(19) United States
(12) Patent Application Publication
(10) Pub. No.: US 2002/0103658 A1
(43) Pub. Date: Aug. 1, 2002

(54) Process for compiling and centralizing business data

(76) Inventors: Vaishali Angal, Sunnyvale, CA (US); Sandeep Nawathe, Sunnyvale, CA (US); Mark Bonham, Palo Alto, CA (US); Ken Leeder, Palo Alto, CA (US)

Correspondence Address: WILSON SONSINI GOODRICH & ROSATI, 650 PAGE MILL ROAD, PALO ALTO, CA, 943041050

(21) Appl. No.: 09/905,400

(22) Filed: Jul. 13, 2001

Related U.S. Application Data
(60) Provisional application No. 60/265,645, filed on Jan. 31, 2001.

(51) Int. Cl. G06F 17/60

(52) U.S. Cl. 705/1

(57) ABSTRACT

A method for the compilation, organization, and dissemination of business information is provided wherein the information is collected from several sources and then categorized according to it core traits. The core traits are identified by a number of predetermined schema. The schema allows core traits and attributes of company specific and company formatted information to be extracted and stored in a centralized structured database. The database contains generic consistent data regarding each category of information as identified by the schema. Once compiled the information may be accessed by a variety of users. The users can supply a template having areas of needed information identified and categorized by the schema. The information stored in the database that correlates to the template request is downloaded. As the information is provided to the user, the incidence of use is recorded and reports of non-industry or brand specific inspection can be provided to the original creators of the information as well as third parties.

### RELATED APPLICATIONS

This application claims the benefit of U.S. Provisional Application No. 60/265,645 filed on, Jan. 31, 2001, which is incorporated herein by reference in entirety.

### FIELD OF THE INVENTION

This invention is in the field of data management. More particularly the invention is in the field of compiling, structuring, and managing information for the users and creators of such information.

### BACKGROUND OF THE INVENTION

Today the process of creating and distributing information is unorganized, inefficient, and unreliable. Information can be created from a wide variety of both internal and external sources. Likewise, the distribution of business information can occur by using CD's, paper catalogues, brochures and internet web sites, called extranets, as well as many other mediums. This process can be expensive, time consuming, and is often prone to error. A breakdown in the efficient creation and distribution of information degrades both its quality and accuracy and detrimentally impacts the business.

Creators of information, such as manufacturers, must provide its users, retailers and consumers alike, data concerning their products. Data such as technical specifications, warranties, customers support and delivery of information must be supplied to each user by every manufacturer regarding every product. This information is constantly in flux. It must reflect new advances in technology as well as the changing market conditions. Making the situation more complex, manufacturers often possess several product lines, each producing numerous products. These product centers disseminate information within the manufacturer's internal organization in an often chaotic and haphazard manner.

Just as a manufacturer has numerous retailers for its products, a single retailer often sells products from a variety of manufacturers. Each manufacturer typically possesses numerous product lines with a great variety of products. Information concerning these products is often channeled to a central location within the company for dissemination to channel partners or directly to consumers through a variety of mediums. This information is conveyed in a variety of formats. The users must assimilate the data so that it can be presented to the consumer in an efficient and attractive format. This process is time consuming, expensive, and inefficient.

For example, a single large manufacturer of electronic products, such as Sony, has numerous independent retail organizations to market its products. These retail outlets include specialty stores as well as Wal-Mart, Kmart, Sears, Revco, Circuit City, Best Buy and many more. Furthermore, the manufacturer, Sony, can supply each of these retailers numerous different products. Sony has an inherent interest to ensure that the retailer, such as Wal-Mart, is properly and accurately portraying the capabilities and characteristics of its products. Should Wal-Mart or any other retailer fail to properly present a highly sought after capability, Sony would subsequently and needlessly lose market share and revenue to a competitor.

Likewise, the retailer must accurately assimilate information from numerous manufacturers regarding numerous products. This information is normally not delivered in a consistent format nor in one that the retailer would use to market the product. Consequently the information must be interpreted and reformatted repetitively expending both time and often accuracy. Errors or misrepresentations of desirable product qualities can force consumers to seek a competitors product erroneously simply because it is more accurately marketed. Furthermore, modifications in product information such as price or availability must currently be manually inputted once the retailer has received notification from the manufacturer. Delays in forwarding this information to consumers can result in confusion, erosion of market share, and loss of revenue to both the manufacturer and the retailer.

The current state of the art fails to provide a means for organizing and delivering updated information efficiently. Current systems are inconsistent throughout individual industries and among product lines. A centralized location allowing for rapid and accurate updates as well as dissemination of the information is not currently available. Channel partners such as retailers and distributors must rely on each individual manufacturer for timely updates of information. Likewise, the manufacturer must rely on their channel partners to quickly and accurately disseminate their product information to consumers. Finally, there are no means by which a manufacturer or creator of information can determine what aspects of the information are more valued by the consumer.

### SUMMARY OF THE INVENTION

A method for compiling, organizing and disseminating business data is provided wherein a creator of information enters data into a centralized persistent storage system which can later be disseminated to various users. The data can be entered into the storage system by a plurality of methods, accommodating both structured and unstructured formats. The method can be both internally oriented for use within an entity or externally oriented to be used with business partners.

Information is gathered from a number of sources and examined to determine common characteristics and traits. Based on these traits a schema is developed which can be applied to similar information from the original and other sources, extracting the core traits dissociated with brand specific or center specific nomenclature. Having gained a common core of information the data can be converted into Extended Mark-up Language (“XML”) for storage in a Structure Information Management System (“SIMS”).

By applying schema with different levels of detail, the data is categorized and placed into specific content containers according to the pre-established schema. The content containers can be accessed upon request and edited by a plurality of users who have been given access to the information by the creator. The data requested by the user can be placed into a user template, formed using the published schema, that can also be stored in the structured information management system.

### DESCRIPTION OF THE DRAWINGS

The present invention is illustrated by way of example in the following drawings such that like references indicate similar elements. The following drawings disclose various embodiments of the present invention for purposes of illustration only and are not intended to limit the scope of the invention.

FIG. 1 illustrates an embodiment of the process to compile, centralize, and disseminate structured management information in accordance with one embodiment of the present invention.

FIG. 2 is a block diagram of an embodiment of a network system for compiling, centralizing and disseminating structured data.

FIG. 3 illustrates the relationship between a creator content information HTML fragment and a HTML site in accordance with one embodiment of the present invention.

FIG. 4 is a block diagram showing the interactive relationship of the Structured Information Management System with a typical product life cycle of an embodiment of the present invention.

FIG. 5 is a flow diagram for a process for compiling, centralizing and storing business data of one embodiment of the present invention.

FIG. 6 is a flow diagram for a process for dissemination and tracking information stored in a centralized database of one embodiment of the present invention.

### DETAILED DESCRIPTION

The process for compiling and disseminating information involves the gathering of distributed, structured, and unstructured information and assimilating it into a structured persistent storage system. These storage systems include but are not limited to, a Rational Database Management System (“RDBMS”) or an Object Database Management System (“ODBMS). Upon request the information storeed in the system is disseminated to specified users. This information can be maintained in a Structured Information Management System (“SIMS”) according to the nature of the information in an XML format. Several schemas can exist to allow categorization of the information to allow for efficient storing and retrieval of the data. Different schema, in turn, identify different containers of information that are managed by the SIMS. For example in one embodiment, Sony can provide information regarding a number of different products from the same product line. Each compilation of product information will be input into software containers that comply with certain schema. The extraction of the core attributes from the product information that is stored in the database is governed by a schema. Therefore, the schema defines what core traits are contained in the SIMS. Multiple schema can be developed for a wide range of products as well as for a wide range of detail. As the schema organizes and structures the product information it also allows the data to be easily converted to Extended mark-up Language (“XML”).

Schema are developed from examination of the information gathered from a product's source and is updated regularly. While the schema reflects the information gained from multiple sources, it is independent of the providers of information and is applied consistently to all the information. The universal nature of the schema also enables templates for the display of the information to be developed. The published schema allows users to develop a custom presentation format that incorporates the information contained within the SIMS. An effective presentation format combined with a reliable source of accurate product information significantly enhances a retailers ability to present a product to a consumer in a competitive manner.

Containers that comply with the schema, therefore, indicate certain attributes of the information. Thus, information from a creator can entail several containers of data based on one schema as well as multiple sets of conatiners for multiple schemas. Where information is passed between components, either within the SIMS itself or between the SIMS and an outside system as can occur when the information is updated by the creator, the information is laid out in Extended Mark-up Language and can be manipulated using Document Object Model techniques.

The SIMS database can be any open file system or storage means capable of keeping the information in a structured format. Access to the information is controlled by a container-manager. In one embodiment, this container-manager provides manufacturers and retailers specific control to certain proprietary content. The manufacturer can in one embodiment, control which information from the database retailers can access. Additionally, firewalls that will be familiar to one skilled in the art of electronic data protection can be installed to prevent unauthorized intrusion into the system.

In the same manner that content is compiled and managed in a container-based system within the SIMS, retail templates can be uploaded and managed. A retail template is a detailed description of how content should be displayed. It is designed by entities desiring to utilize the data contained within the SIMS using the published schema. A template can contain what font size to use or where pictures should be placed with respect to the technical specifications as well as what size of picture should be utilized. A template can also contain deep links to other templates to aid the consumer in making his or her final product selection. The templates are user specific an are controlled by a template manager. The data housed in the containers fill the templates as required thus providing one avenue for the dissemination of the content. For example a container within the SIMS may contain data elements A,B,C,D,H,K,N,P,R, and Z. One retailer may be interested in displaying elements A,B,H,N,P,R, and Z while another may wish to display B,H,N,P,R, and Z. Since the schema is published each user can customize their templates while being assured that the data elements are accurate.

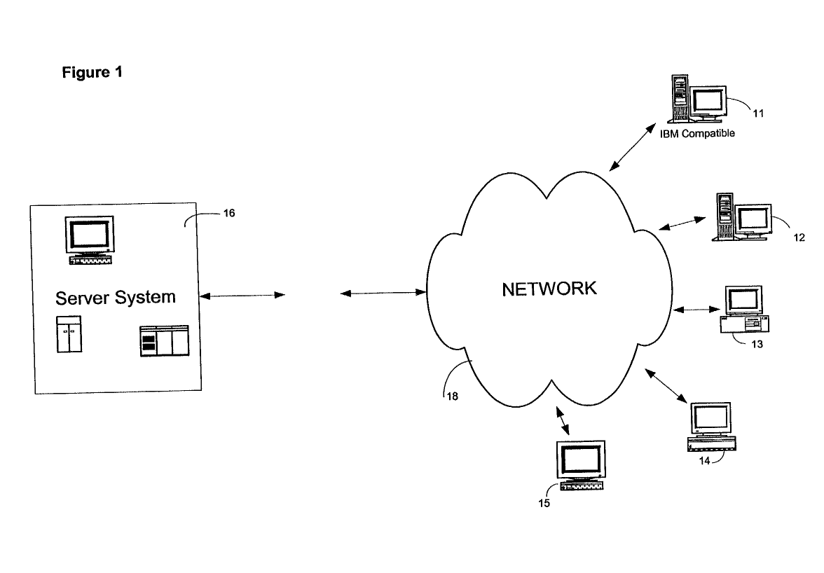

FIG. 1 is an embodiment of a system, 10, for compiling, and centralizing, business data. The system includes multiple client computers, 11-15, which are coupled to the server, 16, through a network, 18. The network, 18, can be any network, such as a local area network, a wide area network, or the Internet. The client computers each include one or more processors and one or more storage devices. Each of the client computers also includes a display device, and one or more input devices. All of the storage devices store various data and software programs.

In one embodiment, the method for compiling, centralizing, and disseminating business data is carried out on the system, 10, by software instructions executing on one or more of the client computers, 11-15. The software instructions may be stored on the server system, 16, or on any one of the client computers. For example, one embodiment presents a hosted application used by a manufacturer that requires input of data from multiple product centers. The software instructions are stored on a central server and accessed through the network by a client computer operator at one of the product centers. In other embodiments, the software instructions may be stored and executed on the client computer. A user of the client computer with the help of a user interface can enter data required for the execution of the software instructions and retrieve data as an output. Data required for the execution of the software instructions can also be accessed via the network and can be stored anywhere on the network.

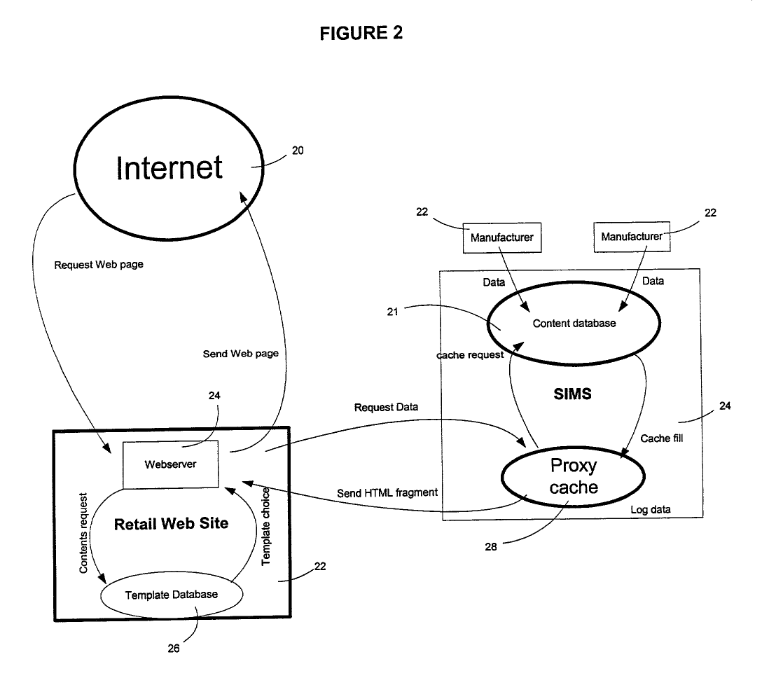

FIG. 2 illustrates one embodiment where a user places a request for information concerning a certain product using the Internet, 20. For example, the user could be a consumer using the Circuit City web site to gain information about a Sony product. The request for a web page is sent to the retail web site, 22, for processing where it is determined what content is requested. The webserver, 24, queries the template database, 26, and finds that Circuit City has a specific format for display of the content. As the template database, 26, returns a particular template, a similar request is forwarded to the content database, 21, for the data. During these processes the request for specific items of content is placed in a proxy cache, 28, where the request is logged along with which content items are requested. While this embodiment shows the proxy cache, 28, as an element of SIMS, 24, it should be noted that the proxy cache, 28, can exist separate from SIMS, 24, and can be integrated with any existing caching system.

After being logged, the request is forwarded to the content database, 21. The content database, 21, searches for the appropriate information or container that was input earlier by the manufacturer, 22. The container possessing Sony information applicable to the data that is requested is located and sent to the proxy cache, 28. The proxy cache forms an HTML fragment containing the appropriate data and forwards the information to the webserver, 24. There the information is placed into the template and forwarded to the user. In this embodiment the template database, 26, and the content database, 20, are not physically collocated. While in other embodiments they can by collocated, there is no requirement that the content database, 20, and the template database, 26, occupy the same location.

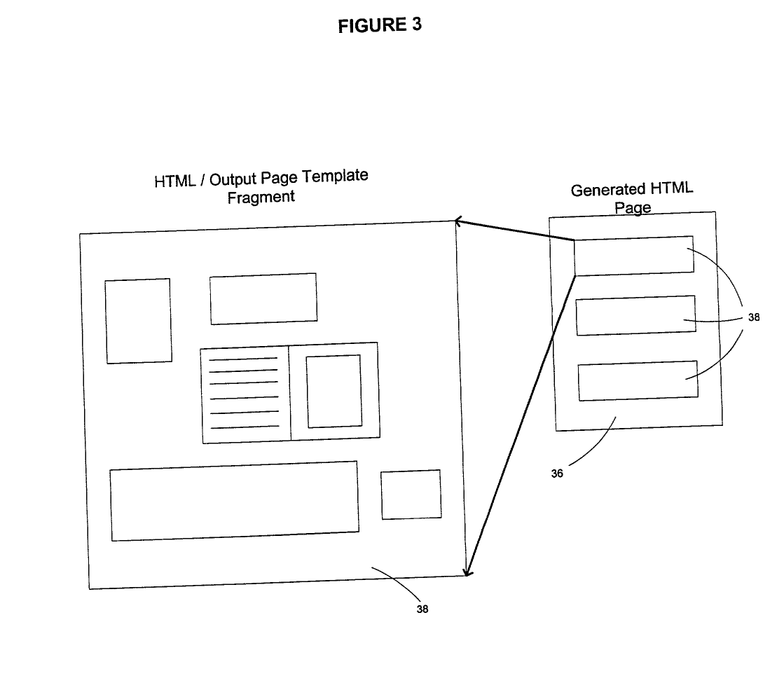

A further illustration of the HTML fragment is shown in FIG. 3. The HTML page, 36, requested by the user can possess a plurality of different HTML fragments, 38, containing information. Perhaps the user in the previous example requested data on a Sony and a Phillips product. The content database, 20, would provide separate HTML fragments, 38, each complying with the Circuit City template, to the webserver, 24, for combination onto the generated HTML page, 36.

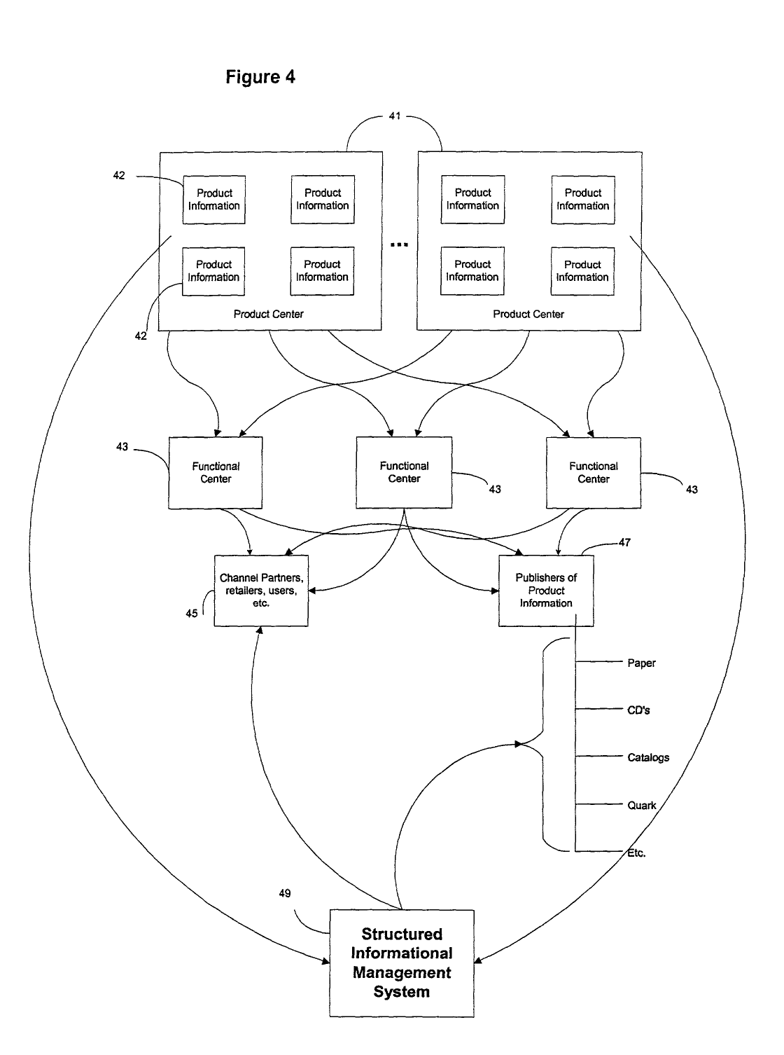

FIG. 4 is a block diagram showing one embodiment of a process for compilation, and centralization of business data. This embodiment illustrates an application of the system in an internal framework. An organization normally possesses several product centers or product lines, 41, each containing a great deal of product information, 42. Normally this information is channeled internally to a central office, such as marketing, where the data is compiled, 43. From here the data is distributed to channel partners, retailers or other users, 45. Additionally this center or other locations may disseminate the information through catalogues, CDs or by other mediums, 47. In this embodiment the SIMS, 49, compiles information from all the product centers and places it into a structured format. Once compiled, the information can efficiently and accurately be distributed to a plurality of locations and through a wide variety of mediums.

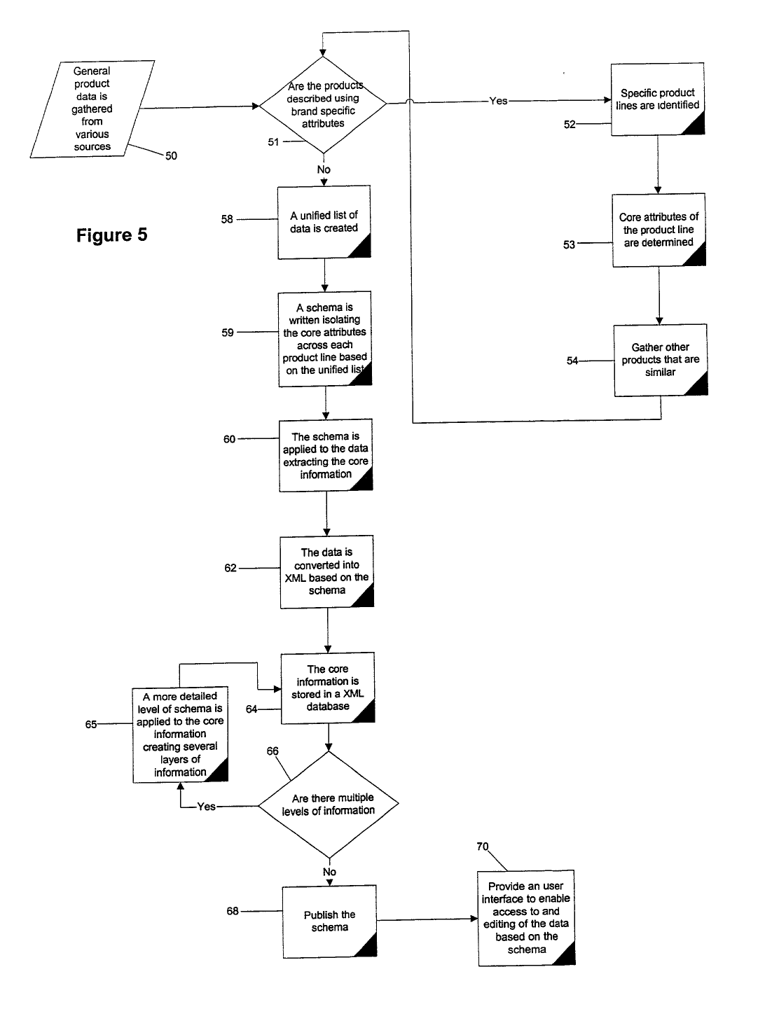

FIG. 5 provides a flow diagram depicting a process for compiling, and centralizing business data of one embodiment. The process begins with information being gathered from a plurality of sources, 50. The system examines the information for brand specific nomenclature, 51 and identifies the core attributes, 53, associated with specific product lines, 52. At the same time other information of the same type is gathered from other sources and examined, 54, to increase the comprehensive nature of the database.

With a unified list of data created, 58, a schema is developed, 59, that isolates the core attributes or traits identified earlier. The schema can be applied to the data acquired from the current and subsequent sources, 60, to extract the core traits. Once extracted, the core traits are converted into XML, 62, and stored in the XML database, 64. As more and more schema are applied, 65, several layers of information, 66, are created forming a structured database of core information. Having developed the database, the schema is published, 68, to enable users to develop templates for utilization of the information. The information can also be altered or deleted through a user interface, 70, that allows the provider of the information to edit the data based on the hierarchy established by the schema.

The dissemination of information, once gathered and organized, can be utilized by users such as, but not limited to, retailers, vendors, and channel partners. Similarly, users can look to the SIMS for information regarding the products they sell regardless of the originating source of the product. While a local distributor can be the actual source for the items, information concerning the product is consistently and accurately found in the specified container in the SIMS that is updated by the manufacturer. This information is in a reliable and structured format allowing it to be applied consistently and accurately in accordance with format specifications, by the template designed by individual users.

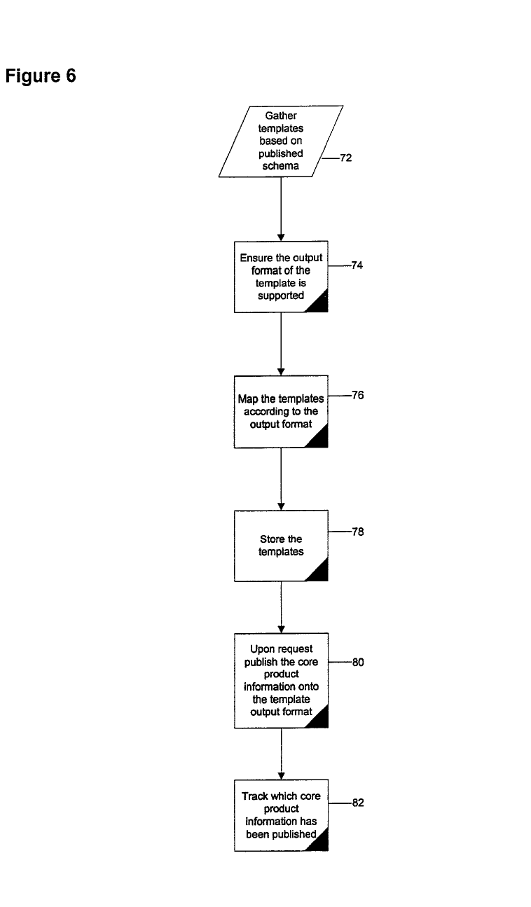

FIG. 6 depicts a flow diagram for an embodiment outlining the dissemination of core data stored in the SIMS. Templates that are designed based on the published schema, 72, are examined to ensure that the format of the template is supported by the data, 74. The template is then mapped according to the output format, 76, aligning data containers with specific portions of the template, 76. The templates are stored in either the SIMS or independently, 78, by the user. Once a request for the template is established, the core information from the SIMS associated with the template is placed is placed onto the template format, 80. The information contained in the output, therefore, is the most accurate data available, yet the format is consistent since the same template is used on every request. Lastly the request for core information is tracked, 80, so as to facilitate both the creators and users ability to fine-tune the product and presentation.

Structured information in one embodiment is defined such that each unit of structured information data complies with pre-existing schema. The schema is established by examining an industry segment or area of competition. Upon request, structured and coherent information can be drawn out of the SIMS from various categories and from various creators. Information regarding presentation format such as the templates is separate from the content and stored separately. Furthermore, structured information can be categorized by and associated with multiple creators. The information is placed into structured containers that can also point the system to accessories associated with the data. Inter-container relationships such as but not limited to kits, indicating a level of required elements, and sets, indicating a possible combination of elements, exist.

The SIMS is therefore designed to allow users of the information to overlay a display or presentation template onto the information. The categorization of the information allows the user to identify data by certain attributes. Information identified by the template is retrieved from the SIMS and inserted creating a customized format with current and accurate information. In one embodiment, certain information regarding a product can reside in multiple categories and similarly the category can be common to several creators. For example, the temperature rating of a sleeping bag can categorize it as extreme conditions gear while it can also be associated with an overall weight category that consumers find critical in making their purchase decisions. These categories, which identify the core traits of a product, can include but are not limited to physical characteristics, reliability specifications, durability ratings, availability status, price, shipping information, warranty coverage, consumer reviews, and technical specifications. Furthermore, there can be many manufacturers that produce similar sleeping bags meeting the same criteria. Comparisons can be done with products of similar categories that facilitate on-line as well as off-line merchandising. This type of categorization allows the competing brands to be listed side by side in the same retail format for easy comparison.

In another embodiment product information editors can enter new categories into the system, edit existing categories, and most importantly, edit the product information. The embodiment can include a pre-established schema of categories that will apply to information from like creators. For example, one manufacturer can choose to have the category “sporting goods” for its product whereas another might elect the category of “outdoor goods”. However, since both manufacturers compete in the market space of recreational equipment, both will be assigned to an established category encompassing both categories making the information readily available and highly useful. Whereas previously retailers had to match different manufacturers' products into a common category for its sales and merchandising purposes, this embodiment of the invention allows the categories to be cross referenced for easy retrieval. The system is highly flexible and can support multiple categories as defined by, but not limited to, manufacturers, retailers, third parties, and other similar entities.

In another embodiment of the invention, a glossary can be added to the information units. Glossary items are supplementary pieces of information such as but not limited to color, dimensions, and type of material. These glossary items can be used to further describe a certain product.

The compilation of business information can occur by a plurality of methods and be gained from multiple sources. These sources can include but are not limited to manufacturers, service providers, channel partners, retail and wholesale establishments, catalogues, consumer reviews, and the Internet. Likewise, business information can include such things as product data, pricing, availability, inventory, promotions, and other information that businesses find useful in conducting their operations.

This process and system of data compilation and distribution can also be utilized internally by a company just as it can be used between a company and any number of external entities. For example, a company can use this process to organize data from diverse and often geographically separated divisions or product centers regarding multiple aspects of the company. Companies often possess several product line managers that are responsible for the development and marketing of specific products as well as creating and maintaining product information. This information can be and is often diverse and unstructured. Division heads often alter their productivity decisions based on responses and direction from other internal product decisions. Accuracy and timely communication is as critical within a company.

With the information located in one central location, all functional areas of the company have a source of complete and accurate information regarding a variety of topics. Furthermore, once such a system exists, extending it to an outside sources through a nested design of multiple versions of this process allows the company to both control and have access to its internal information while at the same time disseminating the data to its business partners.

One embodiment for the compiling of this information is comprised of three independent operations. These operations include a business information data-exchange channel between the SIMS database and a manufacturer's database, a product information editing source, and a product information entry operation. While the embodiment illustrates the gathering and dissemination of information between a manufacturer and a retailer, the process as illustrated above can be applied to any other situation where there is a need to centralize business information in a structured format and disseminate the information as requested.

The product information data-exchange channel is the process of uploading or populating data files between the source creator databases and the SIMS using the process commonly known and recognized by someone skilled in the art as data-exchange. The creator of the information, such as a manufacturer, often possesses an internal database of product or similar information. This information can be stored in a source creator database. Information from the source creator database is exported to the SIMS on a periodic basis such that the destination structure is maintained. Moreover, the creators, manufacturers, and similar entities can pass updates regarding product specifications and capabilities to the SIMS. In one embodiment a primarily software component called the data-exchange console enables the mapping of items directly from the source database to the SIMS database.

Information can be further assimilated into the SIMS through direct product information editing called data-input. In one embodiment, the process of product editing is undertaken by creators who convert unstructured data into the proper structure for assimilation. The function can include but is not limited to the adding of a new product, a category, adding terms to the glossary, and deleting any expired or outdated information. In one embodiment, these changes can be made to the SIMS by means of an interface management console. The changes made using this console would alter the SIMS and hence provide up-to-date and accurate information to both users and creators. Changes made by data input can include but are not limited to adding a new product, editing an established product, or creating a new group or category of products. In another embodiment, data input can include product associations wherein the creators could mix and match various products together.

In the third method of this embodiment product information is gathered from various sources including but not limited to electronic means, paper, CDs, text documents, and catalogues and then manually converted into a structured format to be uploaded into the SIMS. This process can be done by the creator themselves or by a third party if given the structured format schema which the structured data must follow.

Continuing with the previous example, assume that Sony is a client of the process and desires to store its product information in the SIMS. While Sony may possess the capability to directly supply structured data via the data-exchange channel, some of its information such as location of the items, shipping time etc. can be unstructured. Moreover, while this unstructured data can be inputted via a data-input operation it can also be sent to a third party where it is manually formatted into structured data and inputted into the database. In other embodiments additional or fewer means of assimilating information into the database can exist.

The dissemination of the information allows users to gain access to and display the information in any format that they would like to use on an on-demand basis. One embodiment further provides that access to creator's information can be restricted to only authorized users as specified by the creator.

Delivery of the information can be through a variety of mediums. They include but are not limited to the Internet, wireless devices, television, tapes, paper reports, catalogues, and any other mode, both electronic and conventional, by which information can be delivered and displayed. As in the previous example, Sony, having inputted its product information into the SIMS, can allow certain retailers to have access to all of its product lines while limiting others to only the products targeted for a certain market. These access controls can be both updated at the discretion of the creator and vary depending on market conditions.

The retailers, if authorized to gain access to the information, can download the information into a specifically formatted display. For example, Circuit City and Best Buy can both carry the same Sony product yet the format to display the specifications of the product and what each retailer wants to emphasize based on its business model can vary. Since the content filling the display originates from the creator and is located in the same central location, there are no discrepancies among the retailers. The consumer can, therefore, rely on the accuracy of the information reflected in the brand and not associate retail mistakes with the producer of the product.

As information is updated by the manufacturer, the information in all applicable retail sites can be updated automatically if so chosen by the retailer. For example, Circuit City possess hundred of retail outlets as well as catalogue and web based purchases. Upon notification by the manufacturer that the price of a product is being changed or that the technical specification have been updated, all of Circuit City's retail sites can retrieve disseminated information from the SIMS simultaneously with little to no individual retail site interaction. The retailer no longer needs to be concerned that the information displayed accurately reflects the manufacturer's specifications the manufacturer to rest assured that the consumer is getting correct data.

In one embodiment, the retailer's display system can request subsets of product information units. Since the product information is requested from the SIMS, it is up-to-date based on being entered into by the content database by the creators. The retailers can capitalize on the consistent and reliable attributes of the information and efficiently adopt it to their format.

As described herein one embodiment presents a situation where the retailers can provide to the SIMS a template showing how information is to be displayed. These templates are designed using the published schema to provide a mapping between the display format and the product information that is gained from the SIMS. These templates can be managed and uploaded separately as well as disseminated to other retail outlets. The display information or template does not contain actual product information but only information on how the product will be displayed for a particular retailer. The display information, combined with the source information uploaded into the content database, can be updated as necessary by the retailer and the manufacturer respectively making for an efficient and cost saving method to ensure that retail outlets are displaying current and accurate information.

The distribution management system also tracks the usage patterns of product specific information globally. As information is requested by a template, the system, in one embodiment, tracks which container of information is requested. For example, a manufacturer can ascertain what features of a product, regardless of the manufacturer, are viewed more often by consumers before making a purchase or which feature was reviewed last before the product is rejected from consideration. Sony may determine that all requests regarding information about its CD players include the ability to hold multiple discs while disc sampling rate is rarely of interest. Once a structured informational database of content has been compiled, both retailers and manufactures can gain valuable information regarding consumer use patterns and marketing effectiveness.

In the embodiment illustrated in FIG. 2, requests for data are first stored in a proxy cache, 28. The proxy cache enables a log to be compiled of specific content requests. This log can then be used to generate reports on the collection and generation of data. Patterns of user and creator interaction can be obtained upon demand allowing the parties to adjust not only the information contained in the SIMS, but the methods upon which it is marketed. Additionally, the parties can use the information to plan future developmental projects and other operations where such usage patterns would be helpful.

Tracking information can also be used to assess a party's competitive position and improve conversion ratios for product purchases. Furthermore, the tracking allows users to offer promotions that are targeted to specific markets as well as measuring the market impact of those promotions.

One embodiment enables the user to track various levels of interest in a product by examining the navigation habits of the user. For example, a retailer can determine that most consumers exit an Internet site without a purchase after reaching a certain level of the site or informational hierarchy. This information can be used to evaluate future site designs or modifications. Furthermore, the manufacturer may wish to modify a product design based on a high number of rejections after viewing a particular specification. The system also can monitor how a consumer interacts with product information presented by multiple media sources such as, but not limited to, sight and sound presentations. This interaction can be evaluated to determine how a purchase of a product is influenced by the presentation of the information.

In a further embodiment, creators can determine the performance of each user site. By examining the data collected by the proxy cache in the log, creators can determine what creator's data users access more often. Using this knowledge, a manufacturer could target a certain retailer for manufacturer discretionary finds in a goal of enhancing a potential revenue source.

From the above description and drawings, it will be understood by those of ordinary skill in the art that the particular embodiments shown and described are for purposes of illustration only and are not intended to limit the scope of the invention. Those of ordinary skill in the art will recognize that the invention can be embodied in other specific forms without departing from its spirit or essential characteristics. References to details of particular embodiments are not intended to be limiting in scope in any fashion.

What is claimed is:

1. A method of managing business data comprising:
gathering product information of at least one product from a plurality of establishments, the product information including a plurality of core traits from the at least one product described by the at least one establishment's brand-specific attributes;
extracting the core traits from the at least one product's product information;
removing the brand-specific attributes from the core traits; and
creating a database including generic core product information from the core traits.

2. The method of claim 1, wherein generic core product information includes information that is utilized by a plurality of establishments as a parameter of the product.

3. The method of claim 1, further comprising storing the core product information in the database.

4. The method of claim 1, further comprising providing access to the core product information regardless of the product information's origin.

5. The method of claim 1, wherein the core traits include at least one trait selected from physical characteristics, reliability specifications, durability ratings, availability status, price, shipping information, warranty coverage, consumer reviews, and technical specifications.

6. The method of claim 1, wherein the core product information is displayable in a user template.

7. The method of claim 1, wherein the establishments are selected from manufacturing establishments, service establishments, retail establishments, channel partners and wholesale establishments.

8. The method of claim 1, wherein extracting includes applying at least one schema making the product information's structure generic.

9. The method of claim 8, wherein the at least one schema enables computer-executable instructions to, when executed in a processing system, cause the processing system to extract the core traits from the product information.

10. The method of claim 1, wherein extracting includes applying at least one schema to the product information defining the core traits of the product information.

11. The method of claim 1, wherein extracting includes placing the core traits into categories.

12. The method of claim 1, wherein extracting includes applying at least one schema to the product information.

13. The method of claim 12, wherein the at least one schema identifies the core traits of the product information.

14. The method of claim 12, wherein the at least one schema removes non-core attributes from the product information.

15. The method of claim 1, wherein extracting includes at least one schema that can be applied successively to the product information creating several layers of core product information.

16. The method of claim 1, wherein extracting includes grouping the core traits according to different schema.

17. The method of claim 10, wherein allowing includes placing the core product information in a user template, the at least one schema identifying the location in the template where the core product information is placed.

18. The method of claim 1 wherein the schema are hierarchical identifying several different levels of detail of core attributes in each layer.

19. The method of claim 1 wherein extracting can occur repetitively to create several layers of core attributes.

20. The method of claim 1, wherein storing includes using a computer readable software language.

21. The method of claim 1, wherein storing includes using extended markup language “(XML”).

22. A method of managing business information comprising:
gathering source specific information from at least one source;
extracting from the source specific product information a plurality of core traits of the source specific product information by applying at least one schema, wherein the at least one schema identifies the core traits of the source specific product information, removing any unrecognized parameters in the source specific product information, and structuring the core traits into categories;
creating a database including generic core product information from the core traits; and
disseminating the core traits by applying the at least one schema to a user template.

23. The method of claim 22, wherein the core traits include at least one trait selected from physical characteristics, reliability specifications, durability ratings, availability status, price, shipping information, warranty coverage, consumer reviews and technical specifications.

24. The method of claim 22, wherein the core product information is placed in a user template.

25. The method of claim 22, wherein extracting includes applying at least one schema identifying generic core product information.

26. The method of claim 25, wherein the at least one schema enables computer-executable instructions to, when executed in a processing system, cause the processing system to extract the core traits from the product information.

27. The method of claim 22, wherein generic core product information includes information used by a plurality of establishments as parameters of a product.

28. The method of claim 22, wherein extracting includes applying at least one schema to the product information defining the core traits of the product information.

29. The method of claim 22, wherein extracting includes at least one schema that can be applied successively to the product information creating several layers of core product information.

30. The method of claim 22, wherein extracting includes grouping the core traits according to different schema.

31. The method of claim 22, wherein allowing includes placing the core product information in a user template, the at least one schema identifying the location in the template where the core product information is placed.

32. A method of disseminating product information comprising;
extracting core traits from product information gained from a plurality of product information sources;
storing the core traits in a generic extended markup language (“XML”) database;
applying at least one schema to a user product template such that the at least one schema identifies core attribute requests; and
correlating the core attribute requests with core traits stored in the generic XML database.

33. The method of claim 32, further comprising placing the requested core traits into the user product template.

34. The method of claim 32, further comprising delivering the user product template with the requested core traits by a plurality of output mediums.

35. The method of claim 32, wherein the core traits include at least one trait selected from physical characteristics, reliability specifications, durability ratings, availability status, price, shipping information, warranty coverage, consumer reviews and technical specifications.

36. The method of claim 32, wherein sources include at least one source selected from manufacturing establishments, service establishments, retail establishments, channel partners and wholesale establishments.

37. The method of claim 32, wherein extracting includes applying at least one schema identifying generic core product information.

38. The method of claim 32, wherein the generic core product information includes information utilized by a plurality of establishments as a parameter of the product.

39. The method of claim 32, wherein the at least one schema enables computer-executable instructions to, when executed in a processing system, cause the processing system to extract the core traits from the product information.

40. The method of claim 32, wherein extracting includes applying the at least one schema to the product information defining the core traits of the product information.

41. The method of claim 32, wherein extracting includes applying at least one schema to the product information.

42. The method of claim 32, wherein the at least one schema removes non-core traits of the product information.

43. The method of claim 32, wherein the at least one schema identifies the core traits of the product information by removing any brand specific attributes in the product information.

44. The method of claim 32, wherein extracting includes at least one schema that can be applied successively to the product information creating several layers of core product information.

45. The method of claim 32, wherein extracting includes grouping the core traits according to different schema.

46. The method of claim 32, wherein placing includes the at least one schema identifying the location in the template where the core traits are placed.

47. A method of tracking the use of business information comprising:
extracting from the source specific product information core traits of the product information gained from a plurality of sources by applying at least one schema;
creating a database including generic core traits;
disseminating the core traits by placing the core traits into a user template according to the at least one schema; and
recording the incidence of requests for traits regardless of the sources of the information.

48. The method of claim 47, further comprising correlating the incidence of requests for core traits with specific sources.

49. The method of claim 47, wherein generic core traits includes information that is utilized by a plurality of establishments as a parameter of the product.

50. The method of claim 47, further comprising storing the core traits in the database.

51. The method of claim 47, further comprising providing access to the core traits regardless of the product information's origin.

52. The method of claim 47, wherein the core traits include at least one trait selected from physical characteristics, reliability specifications, durability ratings, availability status, price, shipping information, warranty coverage, consumer reviews, and technical specifications.

53. The method of claim 47, wherein the core product information is displayable in a user template.

54. The method of claim 47, wherein the sources are selected from manufacturing establishments, service establishments, retail establishments, channel partners and wholesale establishments.

55. The method of claim 47, wherein extracting includes applying at least one schema making the core trait structure generic.

56. The method of claim 55, wherein the at least one schema enables computer-executable instructions to, when executed in a processing system, cause the processing system to extract the core traits from the product information.

57. The method of claim 47, wherein extracting includes applying at least one schema to the product information defining the core traits of the product information.

58. The method of claim 47, wherein extracting includes placing the core traits into categories.

59. The method of claim 47, wherein extracting includes applying at least one schema to the product information.

60. The method of claim 59, wherein the at least one schema identifies the core traits of the product information.

61. The method of claim 59, wherein the at least one schema removes non-core attributes from the product information.

62. The method of claim 47, wherein extracting includes at least one schema that can be applied successively to the product information creating several layers of core trait information.

63. The method of claim 47, wherein extracting includes grouping the core traits according to different schema.

64. The method of claim 47, wherein disseminating includes the at least one schema identifying the location in the template where the core product information is placed.

65. The method of claim 47, wherein the schema are hierarchical identifying several different levels of detail of core attributes in each layer.

66. The method of claim 47, wherein extracting can occur repetitively to create several layers of core attributes.

67. The method of claim 50, wherein storing includes using a computer readable software language.

68. The method of claim 50, wherein storing includes using extended markup language “(XML”).

69. A computer readable medium containing executable instructions which, when executed in a processing system, causes the system to:
gather product information from a plurality of establishments, the product information using the establishment's brand-specific attributes to describe a product's core traits;
extract the core traits from the product information by applying at least one schema wherein the at least one schema identifies the core traits of the source specific product information, removes any inconsistencies in the product information, and structures the core traits into categories;
creates a consistent generic Extended Markup Language (“XML”) database of core traits; and
provides access to the core product information.

70. A system for managing business information in a computer network comprising:
at least one client processor operating a client browser coupled among at least one server system and a generic consistent database, wherein the server system gathers business data from a plurality of sources and wherein the database resides independent of the server system or the client processors;
at least one schema, wherein the at least one schema identifies the core information from the business data and stores the core information extracted from the business data in Extended Markup Language (“XML”) in the generic consistent database; and
output templates, wherein the output templates identify core information based on the at least one schema to be accessed from the generic consistent database and disseminated by a plurality of mediums.

71. The system of claim 70, wherein the generic consistent database resides within the server system.

72. A method of managing product information comprising:
compiling a plurality of product information from at least one product center;
forming at least one schema that identifies at least one core attribute of the product information;
applying the at least one schema to the product information to extract the at least one core attribute;
converting the at least one core attribute into Extended Markup Language, (“XML”);
storing the at least one core attribute in an XML database;
publishing the schema; and
displaying the at least one core attribute at a user interface to access and edit.

73. The method of claim 72, wherein the schema are hierarchical identifying several different levels of detail of core attributes in each layer.

74. The method of claim 72, wherein applying can occur repetitively to create several layers of core attributes.

75. The method of claim 72, wherein the core attribute is generic.

76. The method of claim 72, wherein the core attribute information includes information that is utilized by a plurality of establishments as a parameter of the product.

77. The method of claim 1, further comprising providing access to the at least one core attribute of the product information regardless of the product information's origin.

78. The method of claim 72, wherein the at least core attribute includes at least one attribute selected from physical characteristics, reliability specifications, durability ratings, availability status, price, shipping information, warranty coverage, consumer reviews, and technical specifications.

79. The method of claim 72, wherein displaying includes placing a core attribute in a user template.

80. The method of claim 72, wherein the at least one product center is selected from marketing, service, research and development, manufacturing, operations, sales, financial, and administration.

81. The method of claim 72, wherein applying includes making the core attribute's structure generic.

82. The method of claim 72, wherein the at least one schema enables computer-executable instructions to, when executed in a processing system, cause the processing system to extract the at least one core attribute from the product information.

83. The method of claim 72, wherein extracting includes placing the at least one core attribute into categories.

84. The method of claim 72, wherein the at least one schema removes non-core attributes from the product information.

85. The method of claim 72, wherein applying includes applying the at least one schema successively to the product information creating several layers of core attributes.

86. The method of claim 72, wherein applying includes grouping the core traits according to different schema.

87. The method of claim 72, further comprising placing the at least one core attribute in a user template, the at least one schema identifying the location in the template where the at least one core attribute is placed.

88. The method of claim 72, wherein the at least one schema hierarchically identifies several different levels of detail of core attributes in each layer.

89. The method of claim 72, wherein applying can occur repetitively to create several layers of core attributes.

90. The method of claim 72, wherein storing includes using a computer readable software language.

91. A computer readable medium for compiling and disseminating business information containing executable instructions which, when executed in a processing system, cause the system to:
gather product information from a plurality of sources;
extract at least one core trait from the product information;
form at least one generic core trait by removing brand specific attributes from the at least one core trait;
create a database which stores the at least one generic core trait;
place the at least one core trait into a user template;
disseminate the at least one core trait on the user template through a plurality of mediums; and
track which at least one core trait is placed into the user template.

92. A computer readable medium containing executable instructions which, when executed in a processing system, tracks the incidence of examination of product information, comprising:
source specific core traits of the product information extracted from a plurality of sources by applying a schema;
a database of generic core product information allowing dissemination of the core product information with a user template;
recorded incidence of requests for core product information regardless of the source of the information; and
correlated incidence of requests for core product information with specific sources.

93. A method for tracking the incidence of product information examination comprising:
maintaining a database of generic core attributes compiled from information gained from a plurality of sources wherein the generic core attributes are extracted from the information by at least one application of a schema identifying the core attributes;
monitoring a request for the generic core attributes to be placed in a template;
recording the incidence of the request for the generic core attributes regardless of the source; and
correlating the frequency with which the generic core attributes are requested with the template.

94. The method of claim 93, wherein monitoring includes identifying the frequency with which the generic core attributes are requested.

95. The method of claim 93, wherein correlating includes associating the requested generic core attributes with a user.

96. The method of claim 93, wherein generic core attributes includes information that is utilized by the plurality of sources as a parameter of a product.

97. The method of claim 93, further comprising storing the core product information in the database.

98. The method of claim 93, further comprising providing access to the generic core attributes regardless of the generic core attribute's origin.

99. The method of claim 93, wherein the schema defines the core attributes of the information.

100. The method of claim 93, wherein the at schema removes non-core attributes from the information.

101. The method of claim 93, wherein extracting includes the schema being applied successively to the information creating several layers of generic core attributes.

102. The method of claim 93, wherein maintaining includes grouping the generic core attributes according to different schema.

103. The method of claim 93, wherein correlating includes identifying the location in the template where the generic core attributes are placed.

104. The method of claim 93, wherein the schema are hierarchical identifying several different levels of detail of the generic core attributes.

105. The method of claim 93, wherein maintaining includes using a computer readable software language.

106. The method of claim 93, wherein maintaining includes using extended markup language “(XML”).
